(19) United States
(12) Patent Application Publication
(10) Pub. No.: US 2021/0340292 A1
(43) Pub. Date: Nov. 4, 2021

(54) Copolymer Having A Reduced Shutdown Temperature and Articles Made With Same

(71) Applicant: Celanese International Corporation, Irving, TX (US)

(72) Inventors: Christian Ohm, Gernsheim (DE); Kirsten Markgraf, Weinheim (DE); Arvind Yadav, Liederbach am Taunus (DE)

(21) Appl. No.: 17/245,402

(22) Filed: Apr. 30, 2021

Related U.S. Application Data
(60) Provisional application No. 63/019,011, filed on May 1, 2020.

(51) Int. Cl. C08F 210/02; C08K 5/00; C08J 5/18; H01M 50/489; H01M 50/417; H01M 10/0525

(52) U.S. Cl. CPC C08F 210/02; C08K 5/0016; C08J 5/18; H01M 2200/10; H01M 50/417; H01M 10/0525; C08J 2323/08; H01M 50/489

(57) ABSTRACT

A polymer composition for producing gel extruded articles is described. The polymer composition contains polyethylene copolymer particles combined with a plasticizer. The polyethylene copolymer can be a high density polyethylene copolymer made from ethylene and one or more comonomers. The comonomers are incorporated into the polymer for reducing the shutdown temperature of the polymer composition and of polymer articles made from the polymer composition. In one embodiment, the polymer composition is used to form a porous membrane for use of a battery separator.

### RELATED APPLICATIONS

The present application is based upon and claims priority to U.S. Provisional Patent Application Ser. No. 63/019,011, having a filing date of May 1, 2020, which is incorporated herein by reference.

### BACKGROUND

Polyethylene polymers have numerous and diverse uses and applications. For example, high density polyethylenes are valuable engineering plastics, with a unique combination of abrasion resistance, surface lubricity, chemical resistance and impact strength. They find application in the production of high strength fibers for use in ropes and anti-ballistic shaped articles and in the production of other elongated articles, such as membranes for electronic devices. However, since the flowability of these materials in the molten state decreases as the molecular weight increases, processing by conventional techniques, such as melt extrusion, is not always possible.

One alternative method for producing fibers and other elongated components from polyethylene polymers is by gel-processing in which the polymer is combined with a solvent. The resultant gel is extruded into a fiber or membrane, and may be stretched in one or two directions. Also, part or all of the solvent may be removed from the product.

Membranes made from polyethylene polymers through gel-processing can be formed to have many beneficial properties. For instance, the membranes can be formed with micro-pores. Microporous polyethylene membranes formed through gel-processing, for instance, are particularly well suited for use as a separator in a battery, such as a lithium ion battery. The microporous membrane, for instance, can separate an anode from a cathode and prevent a short circuit between the active battery components. At the same time, the microporous membrane permits ions to pass through due to the porous nature of the material. The ion permeability characteristics of the microporous polyethylene membrane makes the material particularly well suited for regulating electrochemical reactions within the battery.

In addition to the microporous nature of the polyethylene membrane and to possessing beneficial strength and other physical properties, the polyethylene membranes also offer what is referred to in the art as having an effective “shutdown effect”. The shutdown effect refers to the self-closing of micro-pores within the polyethylene separator when it surpasses a certain temperature. When the pores in the polyethylene membrane are closed upon reaching a certain temperature, ions can no longer pass through the membrane and the electrochemical function of the battery stops. This effect becomes an important safety feature for the battery as it prevents thermal runaway reactions from continuing and prevents the battery from overheating and creating a potentially hazardous situation.

Although microporous membranes made from high molecular weight polyethylene polymers inherently possess lower shutdown temperatures than many other materials, there is a desire in the art for the polyethylene membranes to have an even lower shutdown temperature without compromising physical properties. In fact, even small decreases in the shutdown temperature of the material can offer dramatic improvements in safety and other functions of the battery. Unfortunately, when efforts are undertaken to reduce the shutdown temperature, other properties of the membrane can be adversely affected. Thus, a need exists for a method and technique of lowering the shutdown temperature of polyethylene membranes without adversely impacting other properties of the material.

### SUMMARY

In general, the present disclosure is directed to polyolefin compositions well suited for gel-processing applications. More particularly, the present disclosure is directed to a polymer composition containing a high density polyethylene polymer well suited for producing microporous, ion permeable membranes that may be used as separators in batteries. In accordance with the present disclosure, the polymer composition is formulated so as to have a lower shutdown temperature so that the membrane becomes substantially impermeable once the membrane is subjected to higher temperatures in a particular environment. For instance, when used as a battery separator, the shutdown temperature of the membrane can prevent the battery from a thermal runaway condition.

In one embodiment, the present disclosure is directed to a polymer composition for producing gel extruded articles. The polymer composition comprises a plasticizer combined with a high density polyethylene copolymer. The copolymer is formed ethylene and a comonomer. The comonomer can comprise an alkene containing 4 to 12 carbon atoms. In accordance with the present disclosure, polymer articles formed from the polymer composition exhibit a shutdown temperature of 134° C. or less when measured according to an impedance test. For instance, the shutdown temperature can be about 133° C. or less, such as about 132° C. or less. In other embodiments, the high density polyethylene copolymer can form a membrane having a shutdown temperature of less than about 131° C., such as less than about 130° C., such as less than about 129° C., such as less than about 128° C., and generally greater than about 120° C., while still having a viscosity number of greater than about 500 mL/g, such as greater than about 600 mL/g, such as greater than about 700 mL/g, such as greater than about 800 mL/g, such as greater than about 900 mL/g, such as greater than about 1,000 mL/g. The viscosity number, for instance, can be up to about 6,000 mL/g.

The high density polyethylene copolymer is generally in a form of particles contained within the polymer composition. The amount of comonomer contained within the high density polyethylene copolymer can depend upon various factors. In general, the high density polyethylene copolymer contains one or more comonomers in an amount greater than about 0.01% by weight, such as in an amount greater than about 0.5% by weight, such as in an amount greater than about 1% by weight, such as in an amount greater than about 2% by weight, such as in an amount greater than about 4% by weight, such as in an amount greater than about 5% by weight, and generally in an amount less than about 25% by weight, such as in an amount less than about 20% by weight, such as in an amount less than about 15% by weight. The comonomer can comprise hexene, octene, butene, pentene, undecane, or mixtures thereof. The high density polyethylene copolymer particles can have a median particle size based on volume of less than about 250 microns, such as less than about 200 microns, such as less than about 150 microns, such as less than about 125 microns, and generally greater than about 50 microns. The number average molecular weight of the high density polyethylene copolymer is generally greater than about 500,000 g/mol, such as greater than about 700,000 g/mol, and generally less than about 15,000,000 g/mol, such as less than about 9,000,000 g/mol, such as less than about 1,800,000 g/mol. The high density polyethylene copolymer particles can be present in the composition in an amount up to about 50% by weight. The high density polyethylene copolymer can be a Ziegler-Natta catalyzed polyethylene.

In one aspect, the only polyolefin polymer contained in the polymer composition is the high density polyethylene copolymer. For instance, polymer articles can be made exclusively from the high density polyethylene copolymer without being combined with other polymers, such as other polyethylene polymers.

In order to form gel extruded articles, the high density polyethylene copolymer is combined with at least one plasticizer. In one aspect, the plasticizer comprises mineral oil, a paraffinic oil, a hydrocarbon, an alcohol, an ether, an ester, or mixtures thereof. In another aspect, the plasticizer comprises decaline, xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, monochlorobenzene, camphene, methane, dipentene, methylcyclopentandiene, tricyclodecane, 1,2,4,5-tetramethyl-1,4-cyclohexadiene, or mixtures thereof.

The present disclosure is also directed to a process for producing polymer articles by forming the polymer composition as described above into a gel-like composition. The gel-like composition is then extruded through a die to form a polymer article. The polymer article, for example, can comprise fibers or a film. The process can further include the step of removing at least a part of the plasticizer from the polymer particle. In one aspect, an extraction solvent can be added to the polymer composition during the process in order to facilitate removal of the plasticizer.

The present disclosure is also directed to a porous membrane made from the high density polyethylene copolymers described above. In one aspect, the first membrane can be a single layer membrane.

The present disclosure is also directed to a battery containing an anode and a cathode. A porous membrane made in accordance with the present disclosure can be placed in between the cathode and the anode for regulating the flow of ions within the battery.

Other features and aspects of the present disclosure are discussed in greater detail below.

### BRIEF DESCRIPTION OF THE DRAWING

The present disclosure may be better understood with reference to the following FIGURE:

FIG. 1 is a cross-sectional view of an electronic device, such as a battery, incorporating a porous membrane made in accordance with the present disclosure.

Repeat use of reference characters in the present specification and drawings is intended to represent the same or analogous features or elements of the present invention.

### Definitions

The shutdown temperature of a polymer article, such as a microporous membrane, can vary depending upon the type of test and instrument used to measure the shutdown temperature. In fact, the shutdown temperature can vary widely depending upon the procedure and equipment used to make the determination. Thus, any reported shutdown temperatures for various products can be much lower than if a different test or technique is used.

In the present disclosure, the shutdown temperature of a polymer article, such as a porous membrane or of a polymer composition can be determined according to the “Impedance Test,” the “Thermomechanical Analysis Test,” and the “Differential Scanning calorimetry Test. The Impedance Test, however, is the only test that directly measures shutdown temperature. The following tests are defined as follows.

Impedance Test

The impedance spectroscopy test setup consists of a glass measurement cell containing two steel electrodes. According to the impedance spectroscopy method, the sample is soaked in an electrolyte (1M LiPF₆ in 1:1 ethylene carbonate/dimethyl carbonate) and assembled into the cell between the electrodes. The measurement cell is then connected to an impedance spectrometer that records impedance spectrum every 50 seconds at a frequency between 100 Hz and 100 kHz. The measurement cell is then placed in an oven and heated over 2 hours from 110° C. to 150° C. while continuously recording impedance spectra. Data evaluation is done with a plot of impedance versus temperature and shutdown temperature is indicated by midway of a steep increase in impedance. The test can be conducted using an HCP-803 potentiostat available from Biologic Science Instruments.

Thermo Mechanical Analysis (TMA Test)

Under the TMA method, the dynamic strain is measured while the sample is subjected to a temperature regime and a static force of 0.2N with a force multiplier of 0.5. The test is performed over a temperature range from room temperature (25-30° C.) to 160° C. with a heating rate of 2° C./min. The frequency is set at 0.1 Hz. Data evaluation is done with a plot of dynamic strain versus temperature and the softening point is indicated by the dynamic strain inflection point. The test can be conducted on a Perkin Elmer DMA 8000 dynamic mechanical analyzer.

Differential Scanning calorimetry (DSC Test)

Using differential scanning calorimetry (DSC), the melting point of the sample can be determined by ISO Test No. 11357 under the following conditions: The sample is heated from 0° C. to 180° C. with a heating rate of 10° C./min and held isothermally for 5 min at 180° C. After the isothermal hold, the sample is cooled to 0° C. with a heating rate of 10° C./min. Finally, the sample is heated to 180° C. with a heating rate of 20° C. The sample is inerted with nitrogen during all steps of the DSC procedure. The test can be conducted using a DSC Q2000 calorimeter available from TA Instruments.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a polymer composition well suited for producing gel extruded articles, such as fibers and films. In one embodiment, for instance, the polymer composition can be used to produce a porous membrane that can be used as a separator membrane in an electronic device, such as a battery. The polymer composition contains a polyethylene copolymer resin, such as high density polyethylene copolymer particles combined with a plasticizer. The high density polyethylene copolymer is formed from ethylene and at least one comonomer. In accordance with the present disclosure, one or more comonomers are chosen in particular amounts that reduce the shutdown temperature of articles made from the polymer composition, such as porous membranes. In one aspect, for instance, a porous membrane can be produced having a relatively low shutdown temperature that is made almost entirely from the high density polyethylene copolymer. In addition to having a relatively low shutdown temperature, polymer articles made in accordance with the present disclosure also have excellent mechanical properties.

In general, any suitable high density polyethylene copolymer may be used to form the primary polymer component and the matrix polymer of the polymer composition. The high density polyethylene copolymer has a density of about 0.93 g/cm³ or greater, such as about 0.94 g/cm³ or greater, such as about 0.95 g/cm³ or greater, and generally less than about 1 g/cm³.

The high density polyethylene copolymer can be a high molecular weight polyethylene, a very high molecular weight polyethylene, and/or an ultrahigh molecular weight polyethylene. “High molecular weight polyethylene” refers to polyethylene compositions (including copolymers) with an average molecular weight of at least about 3×10⁵ g/mol and, as used herein, is intended to include very-high molecular weight polyethylene and ultra-high molecular weight polyethylene. For purposes of the present specification, the molecular weights referenced herein are determined in accordance with the Margolies equation (“Margolies molecular weight”).

“Very-high molecular weight polyethylene” refers to polyethylene compositions with a weight average molecular weight of less than about 3×10⁶ g/mol and more than about 1×10⁶ g/mol. In some embodiments, the molecular weight of the very-high molecular weight polyethylene composition is between about 2×10⁶ g/mol and less than about 3×10⁶ g/mol.

“Ultra-high molecular weight polyethylene” refers to polyethylene compositions with an average molecular weight of at least about 3×10⁶ g/mol. In some embodiments, the molecular weight of the ultra-high molecular weight polyethylene composition is between about 3×10⁶ g/mol and about 30×10⁶ g/mol, or between about 3×10⁶ g/mol and about 20×10⁶ g/mol, or between about 3×10⁶ g/mol and about 10×10⁶ g/mol, or between about 3×10⁶ g/mol and about 6×10⁶ g/mol.

As described above, the high density polyethylene copolymer incorporated into the polymer composition of the present disclosure is formed from a primary monomer ethylene in combination with one or more comonomers. The one or more comonomers are particularly selected in order to produce a polyethylene copolymer that has a dramatically reduced shutdown temperature when formed into polymer articles, such as a porous membrane. In one aspect, the comonomer can be an alkene containing more than about 4 carbon atoms, such as more than about 6 carbon atoms, such as more than 8 carbon atoms and generally less than about 24 carbons atoms, such as less than about 20 carbon atoms, such as less than about 16 carbon atoms, such as less than about 12 carbon atoms, such as less than about 10 carbon atoms.

Particular comonomers that can be incorporated into the high density polyethylene copolymer include hexene, octene, butene, pentene, decene, or mixtures thereof. Particular comonomers that may be used include, but are not limited to, propylene, 1-butene, 1-pentene, 1-hexene, 1-heptene, 1-octene, 4-methylpent-1-ene, 1-decene, 1-dodecene, 1-hexadecene and the like.

The amount that one or more comonomers are incorporated into the high density polyethylene copolymer can depend upon various factors including the desired final molecular weight of the polyethylene copolymer, the process conditions, and the type of polymer structure being formed. In general, one or more comonomers are incorporated into the high density polyethylene copolymer in an amount greater than about 0.01% by weight, such as in an amount greater than about 0.5% by weight, such as in an amount greater than about 0.7% by weight, in an amount greater than about 1% by weight, such as in an amount greater than about 2% by weight, such as in an amount greater than about 5% by weight, such as in an amount greater than about 6% by weight, such as in an amount greater than about 8% by weight, such as in an amount greater than about 10% by weight, such as in an amount greater than about 12% by weight, such as in an amount greater than about 15% by weight, such as in an amount greater than about 17% by weight, such as in an amount greater than about 20% by weight. In general, one or more comonomers are incorporated into the high density polyethylene copolymer in an amount less than about 30% by weight, such as in an amount less than about 25% by weight, such as in an amount less than about 20% by weight, such as in an amount less than about 15% by weight, such as in an amount less than about 10% by weight. Preferred comonomers include hexene, butene, octene, or mixtures thereof.

In one aspect, the amount that one or more comonomers are incorporated into the high density polyethylene copolymer can generally be greater than about 0.01 mol %, such as greater than about 0.1 mol %, such as greater than about 0.7 mol %, such as greater than about 0.9 mol %, such as greater than about 1.2 mol %, such as greater than about 1.5 mol %, such as greater than about 1.7 mol %, such as greater than about 2 mol %, such as greater than about 2.25 mol %, such as greater than about 2.5 mol %, such as greater than about 2.75 mol %, such as greater than about 3 mol %, such as greater than about 3.25 mol %, such as greater than about 3.5 mol %, such as greater than about 3.75 mol %, such as greater than about 4 mol %, and generally less than about 10 mol %, such as less than about 8 mol %, such as less than about 5 mol %, such as less than about 2 mol %, such as less than about 1 mol %.

Any method known in the art can be utilized to synthesize the polyethylene copolymer. The polyethylene copolymer powder is typically produced by the catalytic polymerization of ethylene monomer with one or more other comonomers, with a heterogeneous catalyst and an organo aluminum or magnesium compound as cocatalyst. The ethylene and one or more comonomers are usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid fouling and product contamination.

Suitable catalyst systems include but are not limited to Ziegler-Natta type catalysts. Typically Ziegler-Natta type catalysts are derived by a combination of transition metal compounds of Groups 4 to 8 of the Periodic Table and alkyl or hydride derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum or magnesium compounds, such as for example but not limited to aluminum or magnesium alkyls and titanium, vanadium or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system can be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium(IV) compound and in the range of 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium, magnesium and zinc stearate.

Optionally, other catalysts such as Phillips catalysts, metallocenes and post metallocenes may be employed. Generally a cocatalyst such as alumoxane or alkyl aluminum or alkyl magnesium compound is also employed. Other suitable catalyst systems include Group 4 metal complexes of phenolate ether ligands.

In accordance with the present disclosure, the high density polyethylene copolymer is formed into particles and combined with a plasticizer. In one embodiment, the polyethylene copolymer particles are made from a polyethylene copolymer having a relatively low bulk density as measured according to DIN53466. For instance, in one embodiment, the bulk density is generally less than about 0.4 g/cm³, such as less than about 0.39 g/cm³, such as less than about 0.35 g/cm³, such as less than about 0.33 g/cm³, such as less than about 0.3 g/cm³, such as less than about 0.28 g/cm³, such as less than about 0.26 g/cm³. The bulk density is generally greater than about 0.1 g/cm³, such as greater than about 0.15 g/cm³. In one embodiment, the polymer has a bulk density of from about 0.2 g/cm³ to about 0.27 g/cm³. In an alternative embodiment, the polymer has a bulk density of from about 0.35 g/cm³ to about 0.395 g/cm³.

In one embodiment, the polyethylene copolymer particles can be a free-flowing powder. The particles can have a median particle size (d50) by volume of less than 200 microns. For example, the median particle size (d50) of the polyethylene copolymer particles can be less than about 150 microns, such as less than about 125 microns. The median particle size (d50) is generally greater than about 20 microns. The powder particle size can be measured utilizing a laser diffraction method according to ISO 13320.

In one embodiment, 90% of the polyethylene copolymer particles can have a particle size of less than about 250 microns. In other embodiments, 90% of the polyethylene copolymer particles can have a particle size of less than about 200 microns, such as less than about 170 microns.

The molecular weight of the polyethylene copolymer can vary depending upon the particular application. The polyethylene copolymer, for instance, may have an average molecular weight, as determined according to the Margolies equation. The molecular weight can be determined by first measuring the viscosity number according to DIN EN ISO Test 1628. Dry powder flow is measured using a 25 mm nozzle. The molecular weight is then calculated using the Margolies equation from the viscosity numbers. The average molecular weight is generally greater than about 300,000 g/mol, such as greater than about 500,000 g/mol, such as greater than about 700,000 g/mol, such as greater than about 1,000,000 g/mol, such as greater than about 2,000,000 g/mol, such as greater than about 2,500,000 g/mol, such as greater than about 3,000,000 g/mol, such as greater than about 4,000,000 g/mol. The average molecular weight is generally less than about 15,000,000 g/mol, such as less than about 12,000,000 g/mol. In one aspect, the number average molecular weight of the high density polyethylene polymer can be less than about 4,000,000 g/mol, such as less than about 3,000,000 g/mol, such as less than about 1,800,000 g/mol.

The polyethylene copolymer may have a viscosity number of from at least 100 mL/g, such as at least 500 mL/g, such as at least 600 mL/g, such as at least 700 mL/g, such as at least 800 mL/g, such as at least 900 mL/g, such as at least 1,000 mL/g, such as at least 1,100 mL/g, such as at least 1,200 mL/g, such as at least 1,300 mL/g, such as at least 1,400 mL/g, such as at least 1,500 mL/g, such as at least 2,000 mL/g, such as at least 4,000 mL/g to less than about 6,000 mL/g, such as less than about 5,000 mL/g, such as less than about 4000 mL/g, such as less than about 3,000 mL/g, such as less than about 1,000 mL/g, as determined according to ISO 1628 part 3 utilizing a concentration in decahydronapthalene of 0.0002 g/mL.

The high density polyethylene copolymer may have a crystallinity of less than about 80%, such as less than about 70%, such as less than about 60%, such as less than about 50%, such as less than about 40%, and generally greater than about 30%, such as greater than about 50%, such as greater than about 60%.

In general, the high density polyethylene copolymer particles are present in the polymer composition in an amount up to about 50% by weight. For instance, the high density polyethylene copolymer particles can be present in the polymer composition in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight. The polyethylene copolymer particles can be present in the composition in an amount greater than about 5% by weight, such as in an amount greater than about 10% by weight, such as in an amount greater than about 15% by weight, such as in an amount greater than about 20% by weight, such as in an amount greater than about 25% by weight. During gel processing, a plasticizer is combined with the high density polyethylene copolymer particles which can be substantially or completely removed in forming polymer articles. For example, in one embodiment, the resulting polymer article can contain the high density polyethylene copolymer in an amount greater than about 70% by weight, such as in an amount greater than about 80% by weight, such as in an amount greater than about 85% by weight, such as in an amount greater than about 90% by weight, such as in an amount greater than about 95% by weight.

The effect the shutdown reducing additive has on the shutdown temperature of polymer articles made from the polymer composition can depend upon various factors. In general, one or more comonomers are incorporated into the high density polyethylene copolymer in a manner that reduces the shutdown temperature of the polymer composition and of polymer articles made from the polymer composition, including porous membranes. For example, one or more comonomers can be incorporated into the high density polyethylene copolymer such that the shutdown temperature of the polymer composition is reduced by at least 1.8° C., such as at least 2.2° C., such as at least 2.5° C., such as at least 2.8° C., such as at least 3° C., such as at least 3.3° C., such as at least 3.5° C., such as at least 3.8° C., such as at least 4° C. in comparison to a polymer composition or a polymer article made from a high density polyethylene homopolymer (the same polymer not containing the comonomer). In one aspect, the shutdown temperature of the polymer or polymer composition is reduced by at least 5° C., such as at least 6° C., such as at least 7° C. In one embodiment, the shutdown temperature of the polymer or polymer composition is reduced by no more than about 15° C.

The amount the shutdown temperature is reduced through use of the comonomer(s) is somewhat more important than the final or ultimate shutdown temperature of the polymer composition. The shutdown temperature of articles made from the polymer composition can be at a temperature of 133.7° C. or less, such as 133.4° C. or less, such as 132.9° C. or less, such as 132.5° C. or less, such as 132.3° C. or less, such as 132° C. or less, such as 131.7° C. or less, such as 131.5° C. or less, such as 131.3° C. or less, such as 131° C. or less. The shutdown temperature, for instance, can be 130° C. or less, such as 129° C. or less. The shutdown temperature is generally greater than about 120° C., such as greater than about 125° C. The above shutdown temperatures are based upon measurements of the polymer article using the Impedance Test.

In one embodiment, polymer articles made from the polymer composition are made exclusively from the high density polyethylene copolymer without being combined with other polymers, such as other polyolefin polymers. For instance, in one embodiment, the high density polyethylene copolymer is the only polyethylene polymer contained within the polymer composition and articles made from the composition.

In an alternative embodiment, however, the polymer composition may also contain a shutdown reducing additive in combination with the high density polyethylene copolymer particles in order to further reduce the shutdown temperature. The shutdown reducing additive can also be present in the form of particles that are mixed or blended with the high density polyethylene copolymer particles. Melt blending the high density polyethylene copolymer particles with the shutdown reducing additive, for instance, may produce adverse consequences such as polymer entanglements that can make it difficult to produce gel extruded articles from the polymer composition.

In general, the shutdown reducing additive may comprise high density polyethylene particles that are different than the matrix copolymer, low density polyethylene particles, linear low density polyethylene particles, metallocene linear low density polyethylene particles, polyethylene wax particles, hydrogenated fatty acid particles, particles made from dimers of fatty acids, plastomer particles, elastomer particles, and mixtures thereof.

For example, the shutdown reducing additive can be a low density polyethylene. Low density polyethylene can have a branched structure, which differentiates the polymer from a high density polyethylene or a linear low density polyethylene.

The degree of crystallinity of low density polyethylene can be a function of the amount of short chain branching present on the polymer molecules. The crystallinity of the polymer, for instance, can generally be greater than about 20%, such as greater than about 30%, and generally less than about 50%, such as less than about 40%. The degree of crystallinity of low density polyethylene is generally less than the crystallinity of high density polyethylene, which can have crystallinity values of from about 50% to about 75%.

The low density polyethylene can generally have a narrow molecular distribution or a medium molecular weight distribution. For instance, in one aspect, the molecular weight distribution can be from about 3 to about 5. Alternatively, the molecular weight distribution can be from about 6 to about 12. Molecular weight distribution is defined as the ratio of the weight average molecular weight to the number average molecular weight.

The shutdown reducing additive can also be a linear low density polyethylene. Linear low density polyethylene polymer chains generally have no long chain branching. The linear low density polyethylene can be a polyethylene homopolymer or can be a copolymer of ethylene and higher alpha olefins, such as butene, hexene, or octene. In one aspect, the linear low density polyethylene can have a density of greater than about 0.9 g/cm³, such as greater than about 0.91 g/cm³, and generally less than about 0.93 g/cm³, such as less than about 0.925 g/cm³.

In one aspect, the shutdown reducing additive can be a metallocene linear low density polyethylene. Metallocene linear low density polyethylene is typically tougher than linear low density polyethylene and can have a density of between about 0.915 g/cm³ and about 0.94 g/cm³. The polymer is made using a metallocene catalyst.

The shutdown reducing additive can also be comprised of polyethylene wax particles. A polyethylene wax generally has a vary low molecular weight. For instance, the average molecular weight can be less than about 12,000 g/mol, such as less than about 8,000 g/mol, such as less than about 6,000 g/mol, such as less than about 4,000 g/mol, such as less than about 2,000 g/mol. The number average molecular weight is generally greater than about 200 g/mol, such as greater than about 400 g/mol. Polyethylene waxes are typically polyethylene homopolymers although copolymers exist as well. Polyethylene wax can either be formed from a low density polyethylene or a high density polyethylene. In one aspect, the polyethylene wax can have a molecular weight distribution of from about 1.5 to 5, such as from about 1.5 to about 2.5.

In addition to various polyethylene polymers, the shutdown reducing additive can also comprise a fatty acid derivative, such as a hydrogenated fatty acid or a dimer of a fatty acid. Hydrogenated fatty acids are fatty acids where the majority of double bonds have been converted to single bonds. The hydrogenated fatty acid can be formed from a fatty acid having a carbon chain length of greater than about 12 carbon atoms, such as greater than about 16 carbon atoms, such as greater than about 18 carbon atoms, such as greater than about 20 carbon atoms, such as greater than about 24 carbon atoms, and generally less than about 52 carbon atoms, such as less than about 48 carbon atoms, such as less than about 38 carbon atoms.

Dimers of fatty acids or dimerized fatty acids are prepared by dimerizing unsaturated fatty acids obtained from tall oil. A dimerized fatty acid can be formed from a fatty acid having a carbon chain length as described above with respect to hydrogenated fatty acids.

In still another embodiment, the shutdown reducing additive can comprise elastomer particles. Thermoplastic elastomers include styrenic block copolymers, olefin elastomers, polyester elastomers, polyamide elastomers, and polyurethane elastomers. Styrenic block copolymers include styrene-ethylene-ethylene-propylene-styrene polymers, styrene-ethylene-butylene-styrene polymers, and styrene-butadiene-styrene polymers.

In still another aspect, the shutdown reducing additive can be a plastomer. A plastomer is a polymer material which combines the qualities of elastomers and thermoplastics. In one aspect, a polyolefin plastomer is used that comprises an alpha olefin copolymer, particularly an alpha olefin polyethylene copolymer. Suitable alpha-olefins may be linear or branched (e.g., one or more C1-C3 alkyl branches, or an aryl group). Specific examples include ethylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired alpha-olefin comonomers are ethylene, 1-butene, 1-hexene and 1-octene. The ethylene content of such copolymers may be from about 60 mole % to about 99.5 wt. %, in some embodiments from about 80 mole % to about 99 mole %, and in some embodiments, from about 85 mole % to about 98 mole %. The alpha-olefin content may likewise range from about 0.5 mole % to about 40 mole %, in some embodiments from about 1 mole % to about 20 mole %, and in some embodiments, from about 2 mole % to about 15 mole %. The distribution of the alpha-olefin comonomer is typically random and uniform among the differing molecular weight fractions forming the ethylene copolymer.

The density of the thermoplastic polyolefin may generally be less than about 0.95 g/cc, such as less than about 0.91 g/cc. The density of the polyolefin is generally greater than about 0.8 g/cc, such as greater than about 0.85 g/cc, such as greater than about 0.88 g/cc.

As described above, the shutdown reducing additive is in the form of particles that are combined with the high density polyethylene copolymer particles. In general, the shutdown reducing additive particles have a median particle size by volume of less than about 800 microns, such as less than about 600 microns, such as less than about 400 microns, such as less than about 200 microns. The median particle size of the shutdown reducing additive is generally greater than about 10 microns, such as greater than about 20 microns, such as greater than about 50 microns, such as greater than about 70 microns. In one embodiment, the shutdown reducing additive particles can be selected, ground or milled so that the particle size substantially matches the particle size of the high density polyethylene copolymers particles. For instance, the median particle size of the shutdown reducing additive can be within about 20% (+ or −) such as within about 10% of the median particle size of the high density polyethylene particle.

The shutdown reducing additive generally has a melt flow rate of from about 3 g/10 min to about 50 g/10 min. Melt flow rate can be measured using ISO Test 1133 at a temperature of 190° C. and at a load of 2.16 kg. More particularly, the melt flow rate of the shut reducing additive can be greater than about 5 g/10 min, such as greater than about 7 g/10 min, such as greater than about 10 g/10 min, and generally less than about 40 g/10 min, such as less than about 30 g/10 min, such as less than about 25 g/10 min, such as less than about 20 g/10 min.

The shutdown reducing additive is generally present in the polymer composition in conjunction with the high density polyethylene copolymer particles and the plasticizer in an amount from 1% by weight to about 30% by weight. For example, the shutdown reducing additive can be present in the polymer composition in an amount greater than about 2% by weight, such as in an amount greater than about 4% by weight, such as in an amount greater than about 8% by weight, and generally less than about 20% by weight, such as in an amount less than about 15% by weight.

Once an article is formed from the polymer composition through gel extrusion, as described above, most if not all of the plasticizer can be removed. Thus, the shutdown reducing additive can be present in the final product, such as a porous membrane, in an amount greater than about 3% by weight, such as in an amount greater than about 5% by weight, such as in an amount greater than about 8% by weight, such as in an amount greater than about 10% by weight, such as in an amount greater than about 12% by weight, and generally less than about 30% by weight, such as in an amount less than about 25% by weight.

In addition to the high density polyethylene copolymers particles and optionally a shutdown reducing additive, the polymer composition further contains a plasticizer. In general, any suitable plasticizer can be combined with the other components as long as the plasticizer is capable of forming a gel-like material suitable for gel spinning or extruding.

The plasticizer, for instance, may comprise a hydrocarbon oil, an alcohol, an ether, an ester such as a diester, or mixtures thereof. For instance, suitable plasticizers include mineral oil, a paraffinic oil, decaline, and the like. Other plasticizers include xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, and the like. In one embodiment, the plasticizer may comprise a halogenated hydrocarbon, such as monochlorobenzene. Cycloalkanes and cycloalkenes may also be used, such as camphene, methane, dipentene, methylcyclopentandiene, tricyclodecane, 1,2,4,5-tetramethyl-1,4-cyclohexadiene, and the like. The plasticizer may comprise mixtures and combinations of any of the above as well.

The plasticizer is generally present in the composition used to form the polymer articles in an amount greater than about 50% by weight, such as in an amount greater than about 55% by weight, such as in an amount greater than about 60% by weight, such as in an amount greater than about 65% by weight, such as in an amount greater than about 70% by weight, such as in an amount greater than about 75% by weight, such as in an amount greater than about 80% by weight, such as in an amount greater than about 85% by weight, such as in an amount greater than about 90% by weight, such as in an amount greater than about 95% by weight, such as in an amount greater than about 98% by weight. In fact, the plasticizer can be present in an amount up to about 99.5% by weight.

In order to form polymer articles in accordance with the present disclosure, the high density polyethylene copolymer particles are combined with the plasticizer and extruded through a die of a desired shape. In one embodiment, the composition can be heated within the extruder. For example, the plasticizer can be combined with the particles and fed into an extruder. In accordance with the present disclosure, the plasticizer and particles form a homogeneous gel-like material prior to leaving the extruder for forming polymer articles with little to no impurities.

In one embodiment, elongated articles are formed during the gel spinning or extruding process. The polymer article, for instance, may be in the form of a fiber or a film, such as a membrane.

During the process, at least a portion of the plasticizer is removed from the final product. The plasticizer removal process may occur due to evaporation when a relatively volatile plasticizer is used. Otherwise, an extraction liquid can be used to remove the plasticizer. The extraction liquid may comprise, for instance, a hydrocarbon solvent. One example of the extraction liquid, for instance, is dichloromethane.

If desired, the resulting polymer article can be stretched at an elevated temperature below the melting point of the polymer mixture to increase strength and modulus. Suitable temperatures for stretching are in the range of from about ambient temperature to about 155° C. The draw ratios can generally be greater than about 4, such as greater than about 6, such as greater than about 8, such as greater than about 10, such as greater than about 15, such as greater than about 20, such as greater than about 25, such as greater than about 30. In certain embodiments, the draw ratio can be greater than about 50, such as greater than about 100, such as greater than about 110, such as greater than about 120, such as greater than about 130, such as greater than about 140, such as greater than about 150. Draw ratios are generally less than about 1,000, such as less than about 800, such as less than about 600, such as less than about 400. In one embodiment, lower draw ratios are used such as from about 4 to about 10. The polymer article can be uniaxially stretched or biaxially stretched.

Polymer articles made in accordance with the present disclosure have numerous uses and applications. For example, in one embodiment, the process is used to produce a membrane. The membrane can be used, for instance, as a battery separator. Alternatively, the membrane can be used as a microfilter. When producing fibers, the fibers can be used to produce nonwoven fabrics, ropes, nets, and the like. In one embodiment, the fibers can be used as a filler material in ballistic apparel.

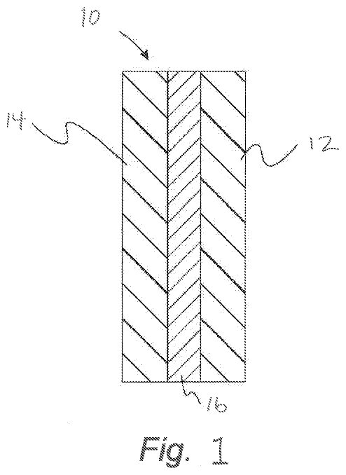

Referring to FIG. 1, one embodiment of a lithium ion battery 10 made in accordance with the present disclosure is shown. The battery 10 includes an anode 12 and a cathode 14. The anode 12, for instance, can be made from a lithium metal. The cathode 14, on the other hand, can be made from sulfur or from an intercalated lithium metal oxide. In accordance with the present disclosure, the battery 10 further includes a porous membrane 16 or separator that is positioned inbetween the anode 12 and the cathode 14. The porous membrane 16 minimizes electrical shorts between the two electrodes while allowing the passage of ions, such as lithium ions. As shown in FIG. 1, in one embodiment, the porous membrane 16 is a single layer membrane and does not include a multilayer structure.

The polymer composition and polymer articles made in accordance with the present disclosure may contain various other additives, such as heat stabilizers, light stabilizers, UV absorbers, flame retardants, lubricants, colorants, and the like.

In one embodiment, a heat stabilizer may be present in the composition. The heat stabilizer may include, but is not limited to, phosphites, aminic antioxidants, phenolic antioxidants, or any combination thereof.

In one embodiment, an antioxidant may be present in the composition. The antioxidant may include, but is not limited to, secondary aromatic amines, benzofuranones, sterically hindered phenols, or any combination thereof.

In one embodiment, a light stabilizer may be present in the composition. The light stabilizer may include, but is not limited to, 2-(2′-hydroxyphenyl)-benzotriazoles, 2-hydroxy-4-alkoxybenzophenones, nickel containing light stabilizers, 3,5-di-tert-butyl-4-hydroxbenzoates, sterically hindered amines (HALS), or any combination thereof.

In one embodiment, a UV absorber may be present in the composition in lieu of or in addition to the light stabilizer. The UV absorber may include, but is not limited to, a benzotriazole, a benzoate, or a combination thereof, or any combination thereof.

In one embodiment, a halogenated flame retardant may be present in the composition. The halogenated flame retardant may include, but is not limited to, tetrabromobisphenol A (TBBA), tetrabromophthalic acid anhydride, dedecachloropentacyclooctadecadiene (dechlorane), hexabromocyclodedecane, chlorinated paraffins, or any combination thereof.

In one embodiment, a non-halogenated flame retardant may be present in the composition. The non-halogenated flame retardant may include, but is not limited to, resorcinol diphosphoric acid tetraphenyl ester (RDP), ammonium polyphosphate (APP), phosphine acid derivatives, friaryl phosphates, trichloropropylphosphate (TCPP), magnesium hydroxide, aluminum trihydroxide, antimony trioxide.

In one embodiment, a lubricant may be present in the composition. The lubricant may include, but is not limited to, silicone oil, waxes, molybdenum disulfide, or any combination thereof.

In one embodiment, a colorant may be present in the composition. The colorant may include, but is not limited to, inorganic and organic based color pigments.

These additives may be used singly or in any combination thereof. In general, each additive may be present in an amount of at least about 0.05 wt. %, such as at last about 0.1 wt. %, such as at least about 0.25 wt. %, such as at least about 0.5 wt. %, such as at least about 1 wt. % and generally less than about 20 wt. %, such as less than about 10 wt. %, such as less than about 5 wt. %, such as less than about 4 wt. %, such as less than about 2 wt. %. The sum of the wt. % of all of the components, including any additives if present, utilized in the polymer composition will be 100 wt. %.

The present disclosure may be better understood with reference to the following example.

### Example

Various different high density polyethylene polymers were produced and tested for various different physical properties, including melting point. In particular, ethylene copolymers were formulated and compared to ethylene homopolymers. Twenty-one different samples were tested. Table 1 below lists all of the samples. As shown below, Sample Nos. 9, 10, and 19 were polyethylene homopolymers. The remaining samples contained an alkylene comonomer. The comonomer amount was varied and is indicated in the table below. The table provides theoretical amounts. Actual comonomer levels may be lower. The following results were obtained:

| | | wt % | mol % | | | | |
|---|---|---|---|---|---|---|---|
| | | Added | Added | Viscosity | Melting | Grain Size | Bulk |
| Sample | | During | During | No. | Temperature | (d50)D50 | density |
| No. | Comonomer | Polymerization | Polymerization | (mL/g) | (° C.) | (microns) | (g/cm³) |
| 1 | Hexene | 2 | 0.67 | 964 | 132.9 | — | — |
| 2 | Hexene | 10 | 3.34 | 1010 | 129.4 | — | — |
| 3 | Decene | 10 | 2.00 | 1072 | 133.9 | — | — |
| 4 | Butene | 5 | 2.50 | 564 | 128.0 | — | — |
| 5 | Butene | 2 | 1.00 | 649 | 131.7 | — | — |
| 6 | Butene | 2 | 1.00 | 731 | 130.8 | — | — |
| 7 | Decene | 2 | 0.40 | 909 | 134.2 | 112 | 0.46 |
| 8 | Octene | 2 | 0.50 | 771 | 134.6 | 116 | 0.40 |
| 9 | none | 0 | 0.00 | 752 | 135.6 | 118 | 0.43 |
| 10 | none | 0 | 0.00 | 957 | 135.7 | 112 | 0.43 |
| 11 | Hexene | 2 | 0.67 | 758 | 133.5 | 113 | 0.43 |
| 12 | Hexene | 2 | 0.67 | 950 | 134.0 | 114 | 0.39 |
| 13 | Hexene | 2 | 0.67 | 575 | 133.6 | 112 | 0.40 |
| 14 | Decene | 2 | 0.40 | 1045 | 135.1 | 110 | 0.41 |
| 15 | Decene | 2 | 0.40 | 734 | 134.8 | 112 | 0.40 |
| 16 | Decene | 2 | 0.40 | 554 | 134.9 | 110 | 0.41 |
| 17 | Octene | 2 | 0.50 | 967 | 134.5 | 112 | 0.41 |
| 18 | Octene | 2 | 0.50 | 655 | 134.3 | 111 | 0.41 |
| 19 | none | 0 | 0.00 | 638 | 135.3 | 111 | 0.42 |
| 20 | Butene | 2 | 1.00 | 3244 | 131.9 | 130 | 0.38 |
| 21 | Butene | 2 | 1.00 | 1027 | 131.9 | 110 | 0.39 |

As shown above, adding a comonomer to the polyethylene polymer reduced the melting temperature.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition for producing gel extruded articles comprising:
a plasticizer;
a high density polyethylene copolymer formed from ethylene and a comonomer, the comonomer comprising an alkene containing 4 to 12 carbon atoms.

2. A polymer composition as defined in claim 1, wherein the high density polyethylene copolymer contains the comonomer in an amount from about 0.01% to about 25% by weight.

3. A polymer composition as defined in claim 1, wherein the comonomer comprises 1-hexene.

4. A polymer composition as defined in claim 1, wherein the comonomer comprises 1-butene.

5. A polymer composition as defined in claim 1, wherein the comonomer comprises 1-octene, 1-pentene, or 1-decene.

6. A polymer composition as defined in claim 1, wherein the polymer composition contains a single polyolefin polymer, the single polyolefin polymer comprising the high density polyethylene copolymer.

7. A polymer composition as defined in claim 1, wherein the shutdown temperature is at least 1.4° C. lower than a polymer composition where the high density polyethylene copolymer is replaced by a similar high density polyethylene homopolymer not modified by an alpha olefin comonomer.

8. A polymer composition as defined in claim 1, wherein the high density polyethylene copolymer comprises particles having a median particle size based on volume of less than about 250 microns, and generally greater than about 50 microns.

9. A polymer composition as defined in claim 1, wherein the high density polyethylene copolymer has a number average molecular weight of greater than about 500,000 g/mol, and less than about 15,000,000 g/mol.

10. A polymer composition as defined in claim 1, wherein the high density polyethylene copolymer particles are present in the composition in an amount up to about 50% by weight.

11. A polymer composition as defined in claim 1, wherein the plasticizer comprises mineral oil, a paraffinic oil, a hydrocarbon, an alcohol, an ether, an ester, or mixtures thereof.

12. A polymer composition as defined in claim 1, wherein the plasticizer comprises decaline, xylene, dioctyl phthalate, dibutyl phthalate, stearyl alcohol, oleyl alcohol, decyl alcohol, nonyl alcohol, diphenyl ether, n-decane, n-dodecane, octane, nonane, kerosene, toluene, naphthalene, tetraline, monochlorobenzene, camphene, methane, dipentene, methylcyclopentandiene, tricyclodecane, 1,2,4,5-tetramethyl-1,4-cyclohexadiene, or mixtures thereof.

13. A polymer composition as defined in claim 1, wherein the high density polyethylene copolymer is a Ziegler-Natta catalyzed high molecular weight polyethylene.

14. A process for producing polymer articles comprising:
forming the polymer composition as defined in claim 1 into a gel-like composition;
extruding the gel-like composition through a die to form a polymer article, the polymer article comprising fibers or a film.

15. A process as defined in claim 14, further comprising the step of removing at least part of the plasticizer from the polymer article.

16. A process as defined in claim 14, wherein an extraction solvent is added to the polymer composition during the process in order to facilitate removal of the plasticizer from the polymer article.

17. A process as defined in claim 16, wherein the extraction solvent comprises dichloromethane.

18. A porous membrane comprising:
a high density polyethylene copolymer, the high density polyethylene copolymer formed from ethylene and a comonomer, the comonomer comprising an alkene; and
wherein the porous membrane exhibits a shutdown temperature of 133° C. or less when measured according to an Impedance Test.

19. A porous membrane as defined in claim 18, wherein the porous membrane is a single layer membrane.

20. A battery comprising an anode, a cathode, and a porous membrane as defined in claim 18 positioned between the anode and the cathode.

21. A porous membrane as defined in claim 18, wherein the comonomer comprises 1-hexene or 1-butene, the high density polyethylene copolymer having a melting temperature of less than 133° C., the comonomer content being from about 0.05 mol % to about 3.5 mol %, the polyethylene copolymer having a bulk density of 0.41 g/cm³ or less, the high density polyethylene copolymer having a viscosity number of from about 500 mL/g to about 6,000 mL/g.
